(19) United States
(12) Patent Application Publication
(10) Pub. No.: US 2008/0244943 A1
(43) Pub. Date: Oct. 9, 2008

(54) Variable Baffle for Low Resolution Displays

(75) Inventors: Christopher Varrin, Los Gatos, CA (US); Matthew E. Ward, Philadelphia, PA (US); Jeremy R. Hochman, Austin, TX (US)

Correspondence Address: Element Labs, Inc., 3350 Scott Blvd., Bldg 2, Santa Clara, CA, 95054, US

(73) Assignee: Element Labs, Inc., Santa Clara, CA (US)

(21) Appl. No.: 12/062,736

(22) Filed: Apr. 4, 2008

Related U.S. Application Data
(60) Provisional application No. 60/910,505, filed on Apr. 6, 2007.

(51) Int. Cl. G09F 9/00

(52) U.S. Cl. 40/452; 29/428

(57) ABSTRACT

A display system comprising a substrate, a first light emitting element mounted on the substrate, a second light emitting element mounted on the substrate adjacent to the first light emitting element, and a baffle disposed between the first light emitting element and the second light emitting element.

### CROSS-REFERENCE TO RELATED APPLICATIONS

This application, pursuant to 35 U.S.C. § 119(e), claims priority to U.S. Patent Application Ser. No. 60/910,505 filed on Apr. 6, 2007 and entitled “VARIABLE BAFFLE FOR LOW RESOLUTION DISPLAYS” in the name of Christopher Varrin, Matthew Ward, and Jeremy Hochman, which is hereby incorporated by reference in its entirety.

### BACKGROUND

1. Field of the Disclosure

Embodiments disclosed herein generally relate to light emitting apparatuses. More specifically, embodiments disclosed herein relate to an improved method and apparatus for emitting light, in which the light emitting apparatus may be used within many different environments.

2. Background Art

Display units for entertainment, architectural, and advertising purposes have commonly been constructed from numbers of light emitting elements, such as light emitting diodes (“LEDs”) or incandescent lamps mounted onto flat panels. The light emitting elements may be selectively turned on and off to create patterns, graphics, and video displays for both informational and aesthetic purposes. It is well known to construct these displays as tiles or large panels which are assembled in position for a specific entertainment show or event, or also as an architectural or advertising display. Examples of such systems are disclosed in U.S. Pat. Nos. 6,813,853, 6,704,989 and 6,314,669.

As the LED video market expands into new domains, the classic fixed structure of the LED video panel may become a limitation. Designers, architects, and advertisers may desire the flexibility and versatility to use only one or a few products within the rapidly changing environment of the modern era. For example, a panel or modular box system may work well in a stadium score board or as an advertisement on the Las Vegas Strip, but the large panels may have limitations on transparency and weight.

Accordingly, there may be a requirement at an event or within a theatrical production to use a display system that is easily removable, for example, moving the display system in between scenes of a play and as the needs of the production dictates. A display apparatus constructed as a large panel or as a series of solid tiles bolted or permanently fixed together may be very inappropriate for such an application or need. The displays may be large and heavy, and require abundant support machinery, time, and storage space for installation. For example, as disclosed in U.S. Pat. No. 6,704,989, issued to Lutz, an electronic signal display system requires the individual display sections be lifted out of storage cases with a lifting truss and then joined and stacked appropriately for display.

To improve upon these limitations, as described above, many existing products are being developed with a degree of transparency and to weigh less than their panel based counterparts. An example of such a prior art display apparatus is disclosed in U.S. Pat. No. 6,237,290 (“Tokimoto”).

Tokimoto discloses a system that effectively integrates the electronic and structural components for use in a building. In this case, the LED ribs are incorporated into a void in the glass wall of the building. However, there may be limitations to the method disclosed in Tokimoto. For example, maintaining the system within the void is complicated. The system disclosed by Tokimoto could be used to back light a graphic on the glass exterior; however, issues with line of sight would prevent the system from acting as a part of the graphic. This may be the result in the alignment of the system and the graphic shifting as the viewer moves. Further, the system may not function as a finished surface and may be difficult to access and maintain.

Another requirement for display systems used for events, such as theatrical productions, is for the display system to be easily and quickly configurable to display multiple sizes and shapes, thereby allowing the system to suit different installations and logistical constraints. Current products are generally composed of individual light emitting elements that are mounted on a printed circuit board. These current products may be used with an “egg crate” in order to isolate the light emitted in well defined square shapes. In other systems, multiple light emitting element groups are placed behind a single diffuser. In these systems, the light emitted from the light emitting elements is not definitively limited, thus light from one pixel may bleed into light from another pixel. Accordingly, there exists a need for a light emitting apparatus that improves upon these prior art support structures for continued development and success within the various light emitting industries.

### SUMMARY OF THE DISCLOSURE

In one aspect, embodiments of the present disclosure relate to a display system comprising a substrate, a first light emitting element mounted on the substrate, a second light emitting element mounted on the substrate adjacent to the first light emitting element, and a baffle disposed between the first light emitting element and the second light emitting element.

In another aspect, embodiments of the present disclosure relate to a method for constructing a display system comprising providing a substrate, mounting and electronically connecting a first light emitting element on the substrate, mounting and electronically connecting a second light emitting element on the substrate adjacent to the first light emitting element, and inserting a baffle between the first light emitting element and the second light emitting element.

Further, in another aspect, embodiments of the present disclosure relate to a display system comprising a light guide, a substrate disposed within and along a length of the light guide, a plurality of light emitting elements disposed on and electrically connected to a first side of the substrate, and a baffle disposed within the light guide and adjacent to the substrate, wherein the baffle is configured to partition the plurality of light emitting elements such that at least one light emitting element is disposed on each side of the baffle.

Furthermore, in another aspect, embodiments of the present disclosure relate to a display system comprising a frame, a plurality of light guides disposed within the frame, a substrate disposed on a side of the frame, a light emitting element disposed on the substrate and configured to emit light towards the light guides, and a baffle configured to be disposed within a gap formed between a first and a second light guide of the plurality of light guides.

Moreover, in another aspect, embodiments of the present disclosure relate to a method for displaying an image comprising providing a substrate for a display system, disposing and electrically connecting a first light emitting element to the substrate, disposing and electrically connecting a second light emitting element to the substrate, disposing a baffle between the first and second light emitting element, electrically connecting the substrate to at least one of a power supply unit and a main processor, and sending a signal from the at least one of the power supply and the main processor to the substrate, wherein the first and second light emitting elements are configured to emit light based on the signal.

Other aspects and advantages of the present disclosure will be apparent from the following description and the appended claims.

### BRIEF DESCRIPTION OF DRAWINGS

FIG. 1 show a side view of a display system in accordance with embodiments of the present disclosure.

FIG. 2A shows a perspective view of a display system in accordance with embodiments of the present disclosure.

FIG. 2B shows a perspective view of a display system in accordance with embodiments of the present disclosure.

FIG. 3 shows a top view of a display system in accordance with embodiments of the present disclosure.

FIG. 4 shows a perspective view of a display system in accordance with embodiments of the present invention.

### DETAILED DESCRIPTION

Specific embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the invention. However, it will be apparent to one of ordinary skill in the art that the embodiments disclosed herein may be practiced without these specific details. In other instances, well-known features have not been described in detail to avoid unnecessarily complicating the description.

In one aspect, embodiments disclosed herein generally relate to a light emitting apparatus having one or more light emitting elements. The light emitting elements are typically electrically connected to a substrate. Further, the light emitting apparatus may include a baffle that is configured to be removably placed, positioned, or disposed in between at least two groups of light emitting elements. The baffle may act as an obstruction that may prevent a light emitted from at least one light element from affecting a light emitted from at least one other light emitting element. Additionally, the baffle may include a deformable material that allows the baffle to be deformed into various shapes. Furthermore, the light emitting apparatus may include a light guide positioned such that it may affect the light emitted from at least one light emitting element.

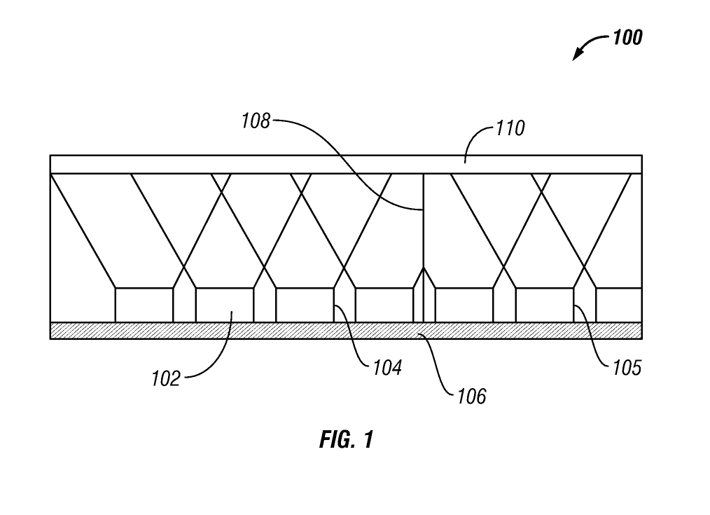

Referring now to FIG. 1, a side view of a display system 100 in accordance with embodiments disclosed herein is shown. As shown, the display system 100 includes a plurality of light emitting elements 102 that are mounted on a substrate 106. Each light emitting element 102 may include one or more light emitters. The light emitters may be the same or different types, may be the same or different colors, or may be the same or different sizes. For example, a light emitter may include a light emitting diode, an organic light emitting diode, a polymer light emitting diode, an incandescent lamp, or any other type of light emitter known in the art. Furthermore, in certain embodiments, the plurality of light emitting elements 102 may be run as one pixel or multiple pixels.

In certain embodiments, the substrate 106 may include a Printed Circuit Board (PCB) that allows the plurality of light emitting elements 102 to be electronically connected to the substrate 106. Further, in certain embodiments, the display system 100 may also include a power unit and/or a main processor that is electronically connected to the plurality of light emitting elements 102. As such, the power unit and/or the main processor may send a data and/or power signal to the plurality of light emitting elements 102. Based on the power signal, the plurality of light emitting elements 102 may be selectively powered on and off or emit light with varying intensities, and based on the data signal, the plurality of light emitting elements 102 may selectively emit light of different colors.

Furthermore, the display system 100 includes a baffle 108 that is configured to be removably attached to the substrate 106. In one embodiment, the baffle 108 may include Velcro that is configured to be removably attached to clips disposed on the substrate 106. In another embodiment, the baffle 108 may include pins that may be received by slots disposed on the substrate 106. The slots may have a smaller diameter than the pins, thereby creating an interference fit that allows the baffles 108 to be removably attached to the substrate 106. One skilled in the art will appreciate that the baffle 108 may include magnets, suction cups, or any other removable attachment feature. Further, in one embodiment, the baffle 108 may be disposed between a first light emitting element 104 and a second light emitting element 105, which may prevent light emitted from the first light emitting element 104 from mixing with light emitted from the second light emitting element 105. Accordingly, the baffle 108 may act as an obstruction to light incident thereon. In one embodiment, the first light emitting element 104 may include a first plurality of light emitting elements, while the second light emitting element 105 may include a second plurality of light emitting elements.

Moreover, the display system includes a light guide 110 configured to direct, modify, or guide light. For example, in one embodiment, the light guide 110 may include a diffuser material so as to diffuse any light emitted through the light guide 110. In another embodiment, the light guide 110 may include a colored material, so as to affect the color of any light emitted through the light guide 110. Further, in certain embodiments, the light guide 110 may include a refractive material, a reflective material, or any other material that is configured to affect the light received upon the light guide 110. One skilled in the art will appreciate that the materials of the light guide mentioned above, may be used individually or in combination when forming the light guide 110.

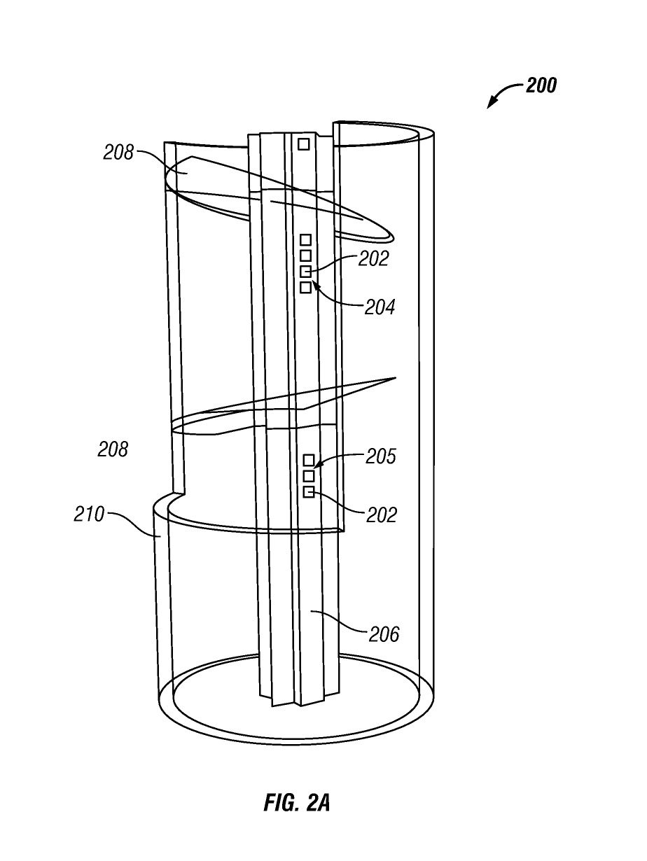

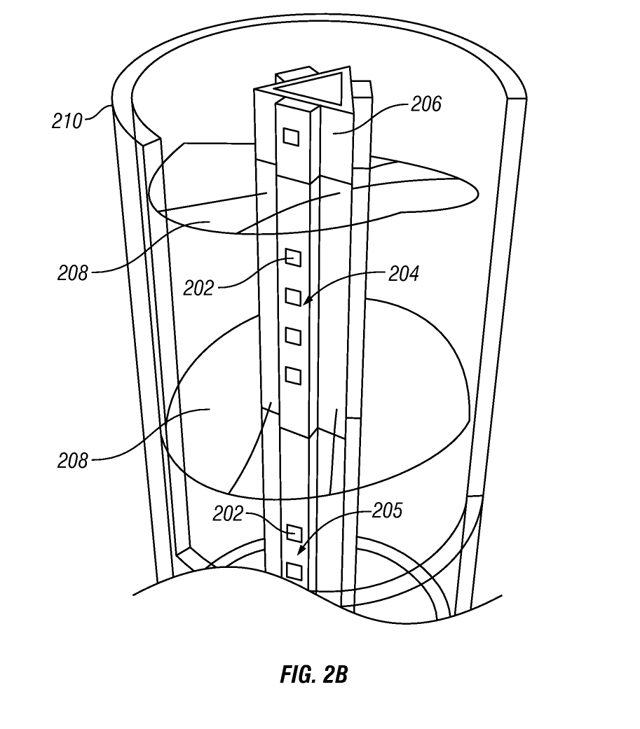

Referring now to FIGS. 2A and 2B, a display system 200 in accordance with embodiments of the present disclosure is shown. The display system 200 includes a substrate 206, baffles 208, and a light guide 210. In one embodiment, the substrate 206 may include light emitting elements 202 mounted and electronically connected thereto. In another embodiment, the substrate 206 may have one side or multiple sides with at least one side having a light emitting element 202 connected thereupon.

The light guide 210 is disposed around the baffles 208 and the substrate 206. Accordingly, during assembly of the display system 200, the baffles 208 and the substrate 206 may be configured to slide into an opening within the light guide 210. In addition, the light guide 210 is configured to direct, modify, or guide light, similar to the light guide 110 shown in FIG. 1. As depicted, the light guide 210 has a circular shape; however, those skilled in the art will appreciate that the light guide 210 may have a rectangular shape, a triangular shape, or any other shape known in the art.

The baffles 208 are configured to be removably attached to the substrate 206, similar to the baffle 108 shown in FIG. 1. In one embodiment, the baffles 208 may be configured to control how much a light emitted from a first group of light emitting elements 204 affects a second group of light emitting elements 205. For example, at least one of the baffles 208 may be disposed between the first group of light emitting elements 204 and the second group of light emitting elements 205, which may prevent a light emitted from the first group of light emitting elements 204 from mixing with a light emitted from the second group of light emitting elements 205. Accordingly, the baffle 108 may act as an obstruction to light incident thereon.

In another embodiment, at least one of the baffles 208 may be disposed between the first group of light emitting elements 204 and the second group of light emitting elements 205, and may allow a portion of a light emitted from the first group of light emitting elements 204 to mix with a light emitted from the second group of light emitting elements 205. Consequently, the display system 200 may display a mixture of light including the light emitted from the first group of light emitting elements 204 and the light emitted from the second group of light emitting elements 205.

Additionally, in certain embodiments, the baffles 208 may different shapes and sizes that correspond with the shape and size of the light guide 210. For example, when the light guide 210 has a circular shape, at least one of the baffles 208 may have a circular, elliptical, and/or oval shape. Further, in certain embodiments, the baffles 208 may have different shapes and sizes that do not correspond with that shape of the light guide 210. For example, when the light guide 210 has a rectangular shape, at least one the baffles 208 may have a triangular, square, and/or circular shape.

Furthermore, in certain embodiments, the baffles 208 may be configured to be formed into any shape. For example, the baffles 208 may include a deformable material, such as metal, plastic, or any other deformable material that allows the baffles 208 to be formed to into various shapes. One skilled in the art will appreciate that by providing the display system 200 with at least one baffle 208 that includes a deformable material, a user may adjust the position and shape of the at least one baffle 208. As such, this may allow the user to adjust a resulting display (e.g., color, tone, shape, size, etc.) of the display system 200 during operation.

In one embodiment, the display system 200 may include baffles 208 having an elliptical shape. During operation, the baffles 208 may be deformed by the user, for example, by pressing down on a surface of the baffles 208. As a result, the baffles 208 may be formed into a “potato chip” shape, as shown in FIG. 2B. Those skilled in the art will appreciate that the “potato chip” shape may create a new look and affect the resulting display of the display system 200.

Moreover, in select embodiments, the baffles 208 may include translucent material, transparent material, perforated material, opaque material, colored material, patterned material, or any other material that may affect the light emitted by the light emitting elements 202.

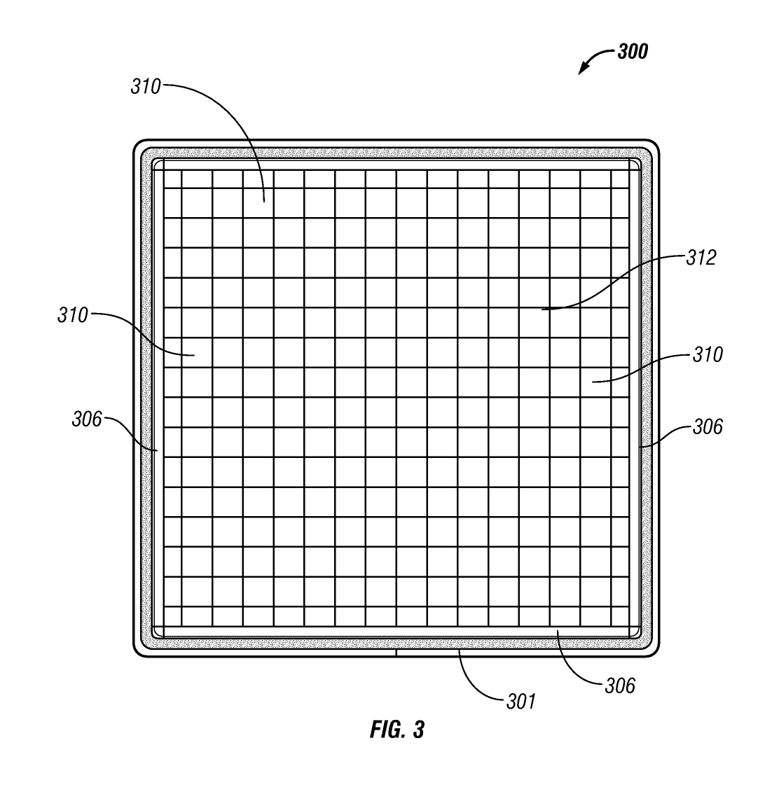

Referring now to FIG. 3, a top view of a display system 300 in accordance with embodiments of the present disclosure is shown. The display system 300 includes at least one substrate 306 disposed on a side of a frame 301. In select embodiments, at least one substrate 306 may be disposed on all sides of the frame 301. Further, each substrate 306 may include at least one light emitting device (not shown) that is electronically connected thereon. The at least one light emitting device may be configured to emit light into a grid of light guides 310. Accordingly, the light guides 310 are configured to affect the light emitted by the at least one light emitting device. Additionally, in certain embodiments, the light guides 310 are disposed such that there are gaps 312 between each light guide 310 in which at least one baffle 308 may be removably inserted.

Although the light guides 310 shown in FIG. 3 are arranged in a grid configuration, those skilled in the art will appreciate that the light guides 310 may be disposed in any configuration. Further, in certain embodiments, the light guide 310 may include an acrylic material, a refractive material, a reflective material, or any other material that is configured to affect the light received upon the light guide 310. Furthermore, the frame 301 may have any shape or size that is desired, for example, a rectangular shape, a triangular shape, or a circular shape.

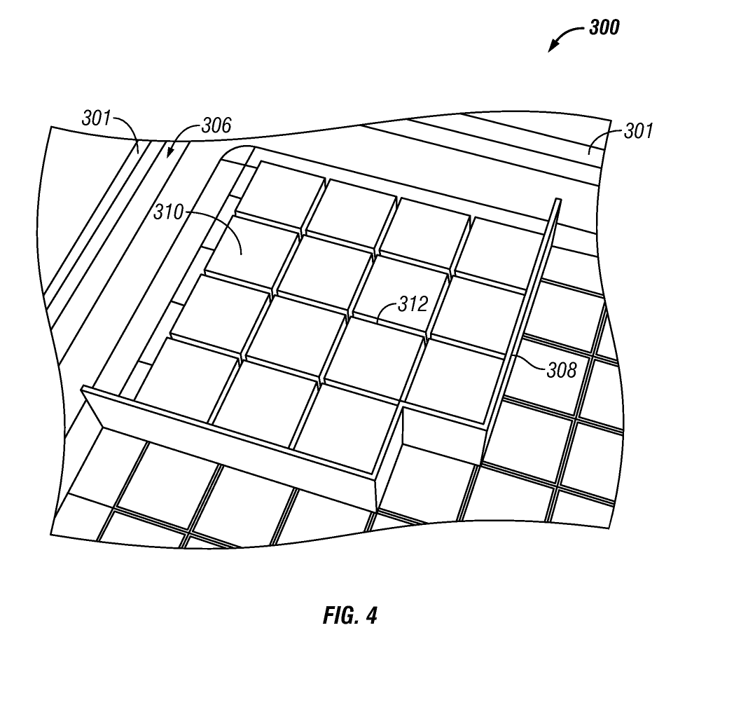

Referring now to FIG. 4, a perspective view of the display system 300 in accordance with embodiments of the present disclosure is shown. As shown, at least one baffle 308 may be removably installed into the gaps 312 around any contiguous grouping of light guides 310. The at least one baffle 308 may include Velcro, magnets, or any other removable attachment feature, as discussed above, that allows the at least one baffle 308 to be removably attached to the frame 301. One skilled in the art will appreciate that by providing at least one baffle 308 that may be removably attached, the user may position the at least one baffle 308 in any configuration around the light guides 310. In some embodiments, a plurality of baffles 308 may be removably installed in various locations and configurations around the light guides 310.

Further, in certain embodiments, the baffles 308 may include a deformable material, similar to the baffles 208 shown in FIGS. 2A and 2B. As such, the baffles 308 may be deformed into any shape or size. Moreover, in another embodiment, the baffles 308 may include an acrylic material, a refractive material, a reflective material, or any other material that is configured to affect the light received upon the baffles 308.

Additionally, in one or more embodiments, gaps 312 between the light guides 310 that are not used may be filled after the installation of the baffles 308. For example, this may be accomplished by filling the unused gaps 310 with a silicon material, or any other filler material known in the art. Accordingly, this may facilitate transmission of light between the light guides 310.

Embodiments disclosed herein may provide for one or more of the following advantages. First, the present disclosure may provide a display system having a user definable border (e.g., baffles and light guides) between adjacent light emitting devices. This display system may increase the versatility to expand the different uses for the system. Next, the present disclosure may provide a display system having a light guide that includes various types of material configured to affect the light emitted from at least one light emitting element. As such, the display system may create various visual effects. Further, the present disclosure may provide for a display system that may be quickly and easily configured. For example, the quick assembly and positioning of the baffles may reduce the setup time of the display system. Finally, the present disclosure may provide for a display system that is adaptable to fit multiple types of environments and various lighting needs. The display system may be customized, such as each baffle and light guide may be customized, to form a display system having different sizes, shapes, and arrangements.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A display system, comprising:
a substrate;
a first light emitting element mounted on the substrate;
a second light emitting element mounted on the substrate adjacent to the first light emitting element; and
a baffle disposed between the first light emitting element and the second light emitting element.

2. The display system of claim 1, wherein the baffle is removably disposed on the substrate.

3. The display system of system of claim 1, wherein the baffle comprises at least one of Velcro, a magnet, or a suction cup.

4. The display system of claim 1, further comprising a light guide disposed over the first and second light emitting elements.

5. The display system of claim 4, wherein the light guide comprises at least one of a diffuser material, an acrylic material, an opaque material, a colored material, a reflective material, and a refractive material.

6. The display system of claim 1, wherein the baffle comprises at least one of a diffuser material, a deformable material, an acrylic material, an opaque material, a colored material, a reflective material, and a refractive material.

7. The display system of claim 1, wherein the baffle is configured to prevent light emitted by the first light emitting element from mixing with light emitted by the second light emitting element.

8. The display system of claim 1, wherein the first light emitting element includes a first plurality of light emitting elements and the second light emitting element includes a second plurality of light emitting elements.

9. A method for constructing a display system, comprising:
providing a substrate;
mounting and electronically connecting a first light emitting element on the substrate;
mounting and electronically connecting a second light emitting element on the substrate adjacent to the first light emitting element; and
inserting a baffle between the first light emitting element and the second light emitting element.

10. A display system, comprising:
a light guide;
a substrate disposed within and along a length of the light guide;
a plurality of light emitting elements disposed on and electrically connected to a first side of the substrate; and
a baffle disposed within the light guide and adjacent to the substrate,
wherein the baffle is configured to partition the plurality of light emitting elements such that at least one light emitting element is disposed on each side of the baffle.

11. The display system of claim 10, wherein the baffle is removably disposed on the substrate.

12. The display system of system of claim 10, wherein the baffle comprises at least one of Velcro, a magnet, or a suction cup.

13. The display system of claim 10, wherein the baffle is configured to prevent light emitted by the first light emitting element from mixing with light emitted by the second light emitting element.

14. The display system of claim 10, wherein the baffle is configured to slide along the substrate.

15. The display system of claim 10, wherein the baffle comprises a deformable material.

16. The display system of claim 10, wherein another plurality of light emitting elements are disposed on and electrically connected to another side of the substrate.

17. The display system of claim 10, wherein the light guide includes one of the group consisting of a circular shape, a elliptical shape, rectangular shape, triangular shape.

18. A display system, comprising:
a frame;
a plurality of light guides disposed within the frame;
a substrate disposed on a side of the frame;
a light emitting element disposed on the substrate and configured to emit light towards the light guides; and
a baffle configured to be disposed within a gap formed between a first and a second light guide of the plurality of light guides.

19. The display system of claim 18, wherein the baffle is further configured to be removably disposed within the gap.

20. The display system of claim 18, wherein the first light guide is positioned between the substrate and the second light guide, and the baffle is positioned between the first light guide and the second light guide.

21. The display system of claim 18, wherein the baffle is configured to prevent light emitted by the light emitting element from reaching the second light guide.

22. The display system of claim 18, wherein a second substrate is disposed on a second side of the frame and a second light emitting element is disposed on the second substrate and configured to emit light towards the plurality light guides.

23. The display system of claim 18, wherein a first light emitting element disposed on the substrate emits light towards the first light guide and a second light emitting element disposed on the substrate emits light towards the second light guide.

24. A method for displaying an image, the method comprising:
providing a substrate for a display system;
disposing and electrically connecting a first light emitting element to the substrate;
disposing and electrically connecting a second light emitting element to the substrate;
disposing a baffle between the first and second light emitting element;
electrically connecting the substrate to at least one of a power supply unit and a main processor; and
sending a signal from the at least one of the power supply and the main processor to the substrate, wherein the first and second light emitting elements are configured to emit light based on the signal.

25. The method of claim 24, wherein the signal comprises at least one of a power signal and a data signal.
